(19) United States
(12) Patent Application Publication
(10) Pub. No.: US 2016/0110810 A1
(43) Pub. Date: Apr. 21, 2016

(54) Research Systems and Methods for Integrating Query Data and Individual User Profile

(71) Applicant: FMR LLC, Boston, MA (US)

(72) Inventors: Rohith Kottamangalam Ashok, Medway, MA (US); Stein Erik Eriksen, Jefferson, MA (US); Srinivasa R. Vagwala, S. Grafton, MA (US); Ramnik Mayor, South Grafton, MA (US)

(21) Appl. No.: 14/516,263

(22) Filed: Oct. 16, 2014

(51) Int. Cl. G06Q 40/06; H04L 29/08; G06F 17/30

(52) U.S. Cl. CPC G06Q 40/06; G06F 17/30867; H04L 67/10; G06F 17/3053

(57) ABSTRACT

Systems and computerized methods are described for providing a research result tailored to user profile data of an account owner. A first server computing device generates a research request based on retrieved user profile data and user query data received from a client device, and transmits the research request to a second server computing device aggregating research data ingested from information sources. The first server computing device receives a research response from the second server computing device and analyzes the research response using a first predetermined metric threshold based on at least a confidence rating associated with each item of research data in the response, and a predetermined reliability rating of its associated information source. The first server computing device formats a research result including the items of research data that exceed the first predetermined metric threshold, and provides the research result to the client device.

### FIELD OF THE INVENTION

The subject matter of this application relates generally to systems and methods for providing a research result tailored to user profile data of an account owner, and in particular, to systems and methods for optimizing a research process utilizing context-integrated research requests to provide a result tailored to user profile data of an account owner.

### BACKGROUND OF THE INVENTION

Modern computing and data networking technology have led to an explosion in the amount of financial news and research data available from countless information sources. Despite the abundance of available information, understanding financial markets and researching potential investments is difficult for most people. The sheer volume of data returned in a typical research session on the internet or via financial services institution websites can require hours of sifting through, for example, content on websites, documents, market research reports, and news stories to identify meaningful research data relevant to an account owner's investment portfolio and investment preferences. Research performed on research systems utilizing existing analytics technologies for searching and analyzing a voluminous corpus of data is limited to searches based on specific search terms provided by a user because existing research systems do not have the ability to blend contextual information from an account owner's investment portfolio or preferences to provide search results better tailored to the account owner.

It is likewise difficult for most people to keep abreast of world events and news that may impact financial markets. The speed of modern information creation and its real time delivery to an ever-growing infrastructure of information sources can prove daunting for individual investors and small advisors. Even large, seasoned advisors and institutional investors can find it impossible to stay ahead of the endless flow of new information. With the fluid nature of the holdings in large investment portfolios, an investment strategy based on research performed one week can be obsolete the next. In addition, large and small advisors are subject to human biases for or against certain investment vehicles or business sectors and may focus their research efforts according to those biases instead of according to an individual investor's portfolio and investment preferences. Furthermore, a typical advisor can work with more than 100 clients, making it difficult perform research tailored to an individual account owner's portfolio and investment preferences.

In some cases, an individual investor can have various questions related to their investment portfolio based on, for example, a current news story or a new investment goal (e.g., saving for a child's college education). In other cases, an individual investor can have an investment-related question based on something they have encountered at a particular location while on vacation or just out running weekly errands. However, having a dialog with a financial expert can be intimidating for an individual investor who is unfamiliar with the various types of investment vehicles available and the operation of the financial markets. Further, an individual investor may not want to incur the expense of an advisor for researching spur of the moment inquiries.

### SUMMARY OF THE INVENTION

Therefore, systems and methods are needed for integrating contextual information related to an account owner and the account owner's portfolio with analytics technology for searching and analyzing a corpus of real time and historical data for financial research. The systems and methods described herein have the advantage of providing a research system that can perform research customized to any account owner's investment portfolio and/or investment preferences to provide more useful and meaningful research results tailored to the account owner. Another advantage of the invention is that it generates context-integrated research requests that expedite the research process by reducing the number of CPU transactions required to return useful and meaningful research results and likewise reducing the consumption of network bandwidth and resources required to conduct research.

The invention, in one aspect, features a computerized method for providing a research result tailored to user profile data of an account owner. A first server computing device receives user query data from a client device. The first server computing device retrieves user profile data associated with an account owner of one or more financial accounts. The first server computing device generates a research request based on the user profile data and the user query data. The first server computing device transmits the research request to a second server computing device, the second server computing device aggregating research data ingested from a plurality of information sources. The first server computing device receives a research response from the second server computing device. The research response includes a list of items of research data corresponding to the research request, and a confidence rating associated with each item of research data. The first server computing device analyzes the list of items of research data in the research response using a first predetermined metric threshold, the first predetermined metric threshold based on at least the confidence rating associated with each item of research data, and a predetermined reliability rating of the information source associated with each item of research data. The first server computing device formats a research result including the items of research data that exceed the first predetermined metric threshold, and provides the research result to the client device.

In some embodiments, the second server computing device ingests research data from one or more real-time information sources. In some embodiments, the first server computing device determines a location of the client device based on one or more of global positioning system (GPS) coordinates provided by a mobile device, an internet protocol (IP) address of the client device, radiolocation information from a cellular network used by the client device, and physical location data obtained from a positioning system in communication with the client device. In some embodiments, the step of generating the research request is further based on the location of the client device. In some embodiments, the step of generating the research request is further based on one or more of a time of day the client device is at the location and a duration the client device remains at the location.

In some embodiments, the first server computing device assigns a weight value to each item of research data included in the research result, the weight value calculated based on an impact to an investment vehicle discussed in at least one of the items of research data, wherein an impact is predicted or realized, and wherein an impact is further an increase in a value, a decrease in a value, or a substantially unchanging value, and a ratio of the value of the impacted investment vehicle in an investment portfolio owned by the account owner to the overall value of the investment portfolio owned by the account owner. In some embodiments, the first server computing device sorts the items of research data included in the research result based on the weight value.

In some embodiments, the step of formatting the research result further includes the first server computing device sorting the items of research data included in the research result based on the weight value. In some embodiments, the first server computing device assigns a second weight value to each item of research data included in the research result, the second weight value calculated based on one or more of a publication date of the item of research data, and a volume of items of research data included in the research response that discuss the same impacted investment vehicle. In some embodiments, the step of formatting the research result further includes the first server computing device sorting the items of research data included in the research result based on one or more of the first weight value and the second weight value. In some embodiments, the first server computing device analyzes the list of items of research data using a second predetermined metric threshold, the second predetermined metric threshold based on at least the confidence rating associated with each item of research data, and the predetermined reliability rating of the information source associated with each item of research data. In some embodiments, the first server computing device supplements the research request based on the user profile data when the list of items of research data is between the first predetermined metric threshold and the second predetermined metric threshold. In some embodiments, the first server computing device transmits the supplemented research request to the second server computing device, and receives a second research response from the second server computing device.

In some embodiments, the user profile data includes one or more of financial account position data, an investment goal, an area of interest, a customer service level, an investment type preference indication, and a risk tolerance. In some embodiments, the user profile data includes a list of prior research requests associated with the account owner and a list of prior research responses associated with the account owner. In some embodiments, the plurality of information sources includes one or more of proprietary information, a financial news website, a general news website, a political news website, a social media website, a world news website, and an RSS server. In some embodiments, the proprietary information includes one or more of historical pricing data for one or more financial vehicles, a fund prospectus, a financial whitepaper, and a financial research opinion.

In some embodiments, the step of formatting the research result includes generating a list of the items of research data that exceed the first predetermined metric threshold, and generating a list of one or more ticker symbols for investment vehicles discussed in the items of research data that exceed the first predetermined metric threshold. In some embodiments, the research result comprises one or more of a list of hyperlinks, a digest of the items of research data that are above the first predetermined metric threshold, and the confidence rating associated with each item of research data that exceeds the first predetermined metric threshold.

In some embodiments, the first server computing device spawns a first thread configured to store the research request to a database, and spawns a second thread configured to transmit the research request to the second server computing device, receive the research response from the second server computing device, and store the research response received from the second server computing device to the database, and the first thread and the second thread execute asynchronously.

In some embodiments, the client device is a smartphone device, a personal computing device, a tablet computing device, a telephone, or a wearable communications and computing device. In some embodiments, the first server computing device provides the research result to a second client device.

In some embodiments, the first server computing device sanitizes the user query data before generating the research request. In some embodiments, the step of sanitizing includes the first server computing device removing one or more of a financial account number and personally identifiable information of the account owner from the user query data.

In some embodiments, the step of generating further includes the first server computing device processing the user query data with a natural language processing engine.

The invention, in another aspect, features a computerized method for providing a research alert tailored to user profile data of an account owner. A first server computing device receives a research response including a plurality of items of research data from a second server computing device, the second server computing device aggregating research data from a plurality of real-time information sources. The first server computing device determines an impact to an investment vehicle discussed in one or more items of research data. The impact can be predicted or realized, and can further be an increase in a value of the investment vehicle, a decrease in a value of the investment vehicle, or a substantially unchanging value of the investment vehicle. The first server computing device retrieves user profile data associated with an account owner of one or more financial accounts. The first server computing device determines an impact to the value of an investment portfolio owned by the account owner based on the impacted investment vehicle discussed in the one or more items of research data. The first server computing device assigns a weight value to each of the one or more items of research data discussing the impacted investment vehicle, the weight value being based on one or more of a predetermined reliability rating of the information source associated with each of the one or more items of research data discussing the impacted investment vehicle, and a ratio of the value of the impacted investment vehicle in the investment portfolio owned by the account owner to the overall value of the investment portfolio owned by the account owner. The first server computing device formats a research alert including the one or more items of research data discussing the impacted investment vehicle having a weight value that exceeds a first predetermined metric threshold. The first server computing device provides the research alert to the account owner.

Other aspects and advantages of the invention will become apparent from the following detailed description, taken in conjunction with the accompanying drawings, illustrating the principles of the invention by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a research system according to embodiments of this disclosure.

FIG. 2 is a detailed block diagram of a virtual research advisor server computing device according to embodiments of this disclosure.

FIG. 3 is a detailed block diagram of a query analytics server computing device according to embodiments of this disclosure.

FIG. 4 is a flow diagram of a method for providing a research result tailored to user profile data of an account owner according to embodiments of this disclosure.

FIG. 5 is a flow diagram of a method for providing a research result tailored to user profile data of an account owner according to embodiments of this disclosure.

FIG. 6 is a diagram of exemplary tier value assignments to various information sources according to embodiments of this disclosure.

FIG. 7 is a flow diagram of a method for providing a research alert tailored to user profile data of an account owner according to embodiments of this disclosure.

### DETAILED DESCRIPTION

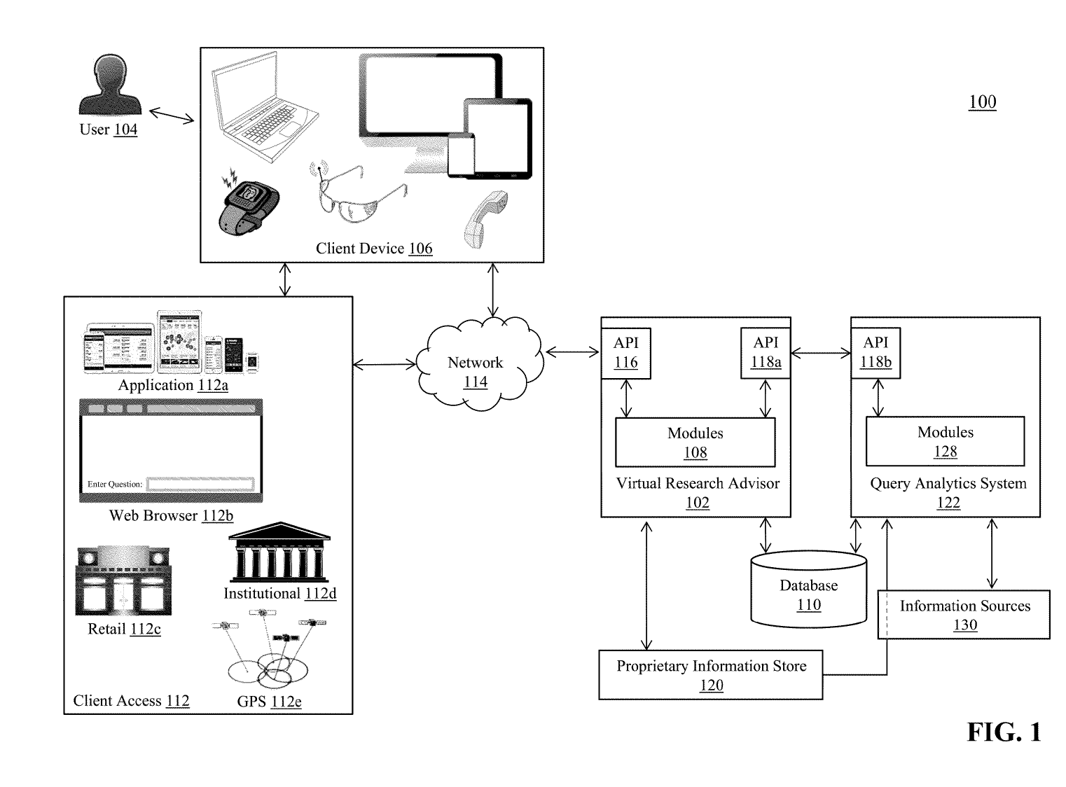

FIG. 1 is a block diagram of a virtual research system 100 for providing a research result tailored to user profile data of an account owner. The system 100 includes a first server computing device 102 (herein after “virtual research advisor 102” or “VRA 102”) having a number of modules 108, application programming interface (“API”) 116 and API 118a-118b (collectively referred to as API 118), a communications network 114, client access 112a-112e (collectively referred to as client access 112), client device 106, and a user 104. System 100 further includes a database 110, a second server computing device 122 (hereinafter “query analytics system 122” or “QAS 122”) having a number of modules 128, a proprietary information store 120, and information sources 130. The server computing devices and their respective modules implement the computer processing in accordance with computer-implemented embodiments of the invention. The methods described herein may be achieved by implementing program procedures, modules and/or software executed on, for example, a processor-based computing device or network of computing devices.

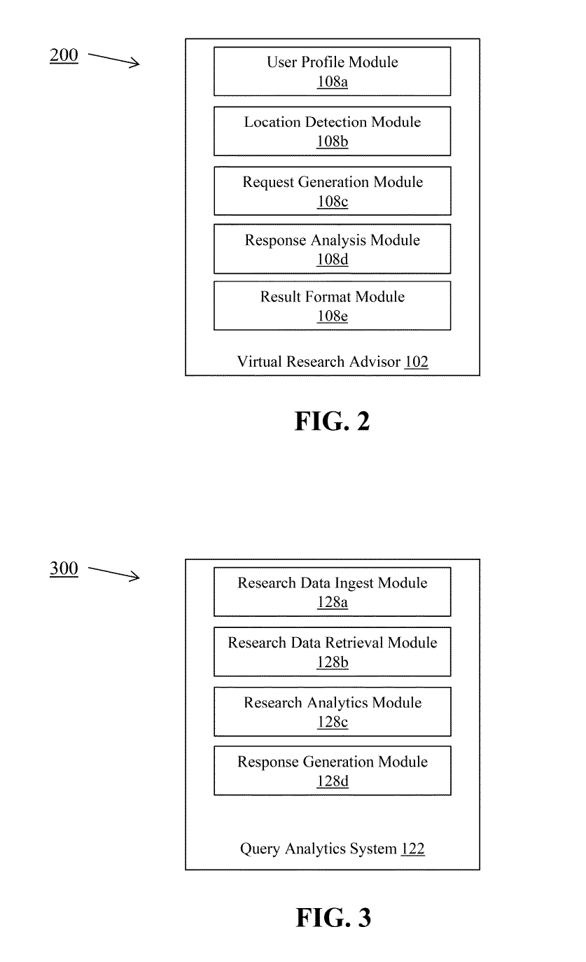

FIG. 2 is a detailed block diagram 200 of the VRA 102 showing the individual modules 108. The VRA 102 includes a user profile module 108a, a location detection module 108b, a request generation module 108c, a response analysis module 108d, and a result format module 108e. The modules 108a-108e are hardware and/or software modules located in the VRA 102 and used during execution of the methods described herein. In some embodiments, the functionality of the modules 108a-108e is distributed among a plurality of computing devices. It should be appreciated that any number of computing devices, arranged in a variety of architectures, resources, and configurations (e.g., cluster computing, virtual computing, cloud computing) can be used without departing from the scope of the invention.

Returning to FIG. 1, the VRA 102 includes network-interface components (not shown) to connect to the communications network 114. In some embodiments, the network-interface components include components to connect to a wireless network, such as a Wi-Fi or cellular network, in order to access a wider network, such as the Internet.

The communications network 114 facilitates communications between the VRA 102 and the client device 106 via client access 112. The communications network 114 may be a local network, such as a LAN, or a wide area network (“WAN”), such as the Internet and/or a cellular network. The communications network 114 may alternatively comprise components of both a LAN and a WAN, or any other type of network known in the art.

As shown in FIG. 1, a user 104 is in communication with a client device 106. The system 100 can be used by various users. In one example, the user 104 is the account owner (e.g., individual investor) of one or more financial accounts who is conducting research related to the financial accounts. In another example, the user 104 is a customer-facing associate of a financial services institution that is assisting an account owner with research related to the account owner's investment portfolio. In another example, the user 104 is a registered independent advisor (“RIA”) conducting research related to an account owner's investment portfolio. In another example, the user 104 is an institutional investor.

At least one client device 106 utilizing a client access 112 interacts with the VRA 102 during execution of the methods described herein. The provided examples of the client device 106 and client access 112 are not limiting and it should be appreciated that any number of client devices with a client access, arranged in a variety of architectures, resources, and configurations can be used without departing from the scope of the invention.

Client device 106 can include, for example, a computer, a mobile device (e.g., cellular phone, personal digital assistant (PDA) device, smart phone, tablet, laptop computer, electronic mail device), wearable computing and communications technology (e.g., Google Glass™, smartwatch), a telephone, and/or other communication devices known in the art.

Client access 112 is generally client access software the client device 106 utilizes to interact with the VRA 102. Client access 112 includes application 112a, web client 112b, retail client 112c, institutional client 112d, and global positioning system (“GPS”) client 112e.

Application 112a can be a client application executing on a full-featured computer or an app executing on, for example, a tablet computer or mobile device. In some embodiments, application 112a includes software code or application code such as Fidelity Mobile®, Active Trader Pro® from Fidelity Investments®.

Web client 112b can be utilized by any web-enabled client device 106 to interact with the VRA 102. For example, web client 112b can be used by a client device 106 executing a web browser application (e.g., Chrome™ from Google, Inc., Microsoft® Internet Explorer® available from Microsoft Corporation, and/or Mozilla® Firefox available from Mozilla Corporation, Safari available from Apple Computer). In one embodiment, web client 112b is web client software executing on a server computing device owned or administered by a financial services institution (e.g., Fidelity Investments). In some embodiments, web client 112b is software code or application code executing in a cloud computing environment.

Retail client 112c can include a client software application executing on a computing device within a branch office or retail location of a financial services institution. In one example, retail client 112c is executing on a computing device used by a customer-facing associate of a financial services institution that is assisting an account owner with research related to the account owner's investment portfolio.

Institutional client 112d can include a client software application executing on a computing device utilized by an organization that manages an investment portfolio (e.g., institutional investor). In one example, institutional client 112d includes software code or application code such as, WealthCentral® from Fidelity Investments®, or StreetScape® from National Financial®.

GPS client 112e can include software code or application code configured to provide location information about the client device 106 to the VRA 102. In some embodiments, GPS client 112e provides location and time information about the client device 106 to the VRA 102. In some embodiments, GPS client 112e provides the location and time information about the client device 106 to the VRA 102 in GPS messages. In some embodiments, GPS client 112e is software code that is part of other client software that interacts with the VRA 102.

Other client access implementations can be used without departing from the scope of the invention. In one example, the client access 112 includes automated speech recognition technology executing on a mobile computing device or on a dial-in call center computing system.

As is readily apparent, the VRA 102 is configured to interact with numerous types of client software to support many diverse user and usage scenarios. The VRA 102 utilizes API 116 to provide a device and software platform agnostic interface for facilitating the interaction between client access 112a-112e and the modules 108. For example, each client access 112 can use a different data format for interacting with the VRA 102. API 116 can receive data from each client access 112 in disparate formats and properly map the data from each format into a common format that can be processed by the modules 108. Likewise, API 116 maps data from the modules 108 into the proper format according to which client access 112 is being used to interact with the VRA 102. In some embodiments, API 116 specifies a software library including specifications for routines, data structures, classes, and variables for interacting between client access 112 and the modules 108. In some embodiments, API 116 includes a specification of remote calls for executing subroutines. In some embodiments, API 116 is based on a representative state transfer (“REST”) architecture.

The VRA 102 is further coupled to a proprietary information store 120, and the QAS 122. The VRA 102 and the QAS 122 are coupled to a database 110. API 118a in the VRA 102 and API 118b in the QAS 122 facilitate communications and data transfers between the two server computing devices. The QAS 122 is further coupled to information sources 130. In some embodiments, the proprietary information store 120 is an information source from which the QAS 122 ingests or retrieves data. FIG. 1 depicts this relationship. For example, FIG. 1 shows proprietary information store 120 further coupled to the QAS 122 by way of a hashed line through information sources 130.

Although not depicted in FIG. 1, a communications network such as the communications network described with respect to communications network 114 can be used to facilitate communication between any of the aforementioned coupled components. Accordingly, each of the aforementioned coupled components includes network-interface components to connect to a communications network similar to communications network 114. In some embodiments, the network-interface components include components to connect to a wireless network, such as a Wi-Fi or cellular network, in order to access a wider network, such as the Internet.

The database 110 stores data associated with the execution of the methods described herein. In some embodiments, the database 110 resides on a separate computing device from the VRA 102 and the QAS 122. In some embodiments, the database 110 is integrated into the VRA 102 or the QAS 122. Although FIG. 1 depicts a single database 110, it should be appreciated that multiple databases can be used without departing from the scope of the invention. As will be described in greater detail below, the database can store a variety of data for each of the modules 108a-108e and modules 128a-128d.

FIG. 3 is a detailed block diagram 300 of the QAS 122 showing the individual modules 128. The QAS 122 includes a research data ingest module 128a, a research data retrieval module 128b, a research analytics module 128c, and a response generation module 128d. The modules 128a-128d are hardware and/or software modules located in the QAS 122 and used during execution of the methods described herein. In some embodiments, the functionality of the modules 128a-128d is distributed among a plurality of computing devices. It should be appreciated that any number of computing devices, arranged in a variety of architectures, resources, and configurations (e.g., cluster computing, virtual computing, cloud computing) can be used without departing from the scope of the invention.

The QAS 122 is generally a query and analytics processing and information retrieval system. In some embodiments, the QAS 122 is an artificially intelligent computing device (e.g., a computing device based on a technology such as Watson Discovery Advisor, Watson Analytics, or Watson Explorer by IBM, Inc.) that is capable of retrieving information in response to queries posed in natural language. In some embodiments, the QAS 122 is a computing device employing a computational engine (e.g., the Wolfram Alpha answer engine developed by Wolfram Research) that is capable of providing answers to factual queries based on a knowledge base of data from a plurality of information sources. In some embodiments the QAS 122 is a computing device comprising an internal or external database or data store for storing and accessing massive volumes of both structured and unstructured data (e.g., big data store).

Although the foregoing examples of the QAS 122 each describe a singular implementation, it should be appreciated that the QAS 122 can include a plurality of computing devices, based on any or all of the above-mentioned examples, and arranged in a variety of architectures, resources, and configurations (e.g., cluster computing, virtual computing, cloud computing) without departing from the scope of the invention. For example, an implementation of the QAS 122 can include a plurality of computing devices based on Watson Discovery Advisor, as well as a plurality of computing devices employing the Wolfram Alpha answer engine and others.

As is readily apparent, the QAS 122 can include numerous types of research analytics systems, each using a different data format for interacting with the VRA 102. API 118a in the VRA 102 and API 118b in the QAS 122 facilitate communications and data exchanges between the two server computing devices. API 118 specifies a common data format and provides a device and software platform agnostic interface for facilitating the interaction between the modules 108 in the VRA 102 and the modules 128 in the QAS 122. In some embodiments, API 118 specifies a software library including specifications for routines, data structures, classes, and variables for interacting between the modules 108 and the modules 128. In some embodiments, API 118 includes a specification of remote calls for executing subroutines. In some embodiments, API 118 is based on a REST architecture.

As shown in FIG. 1, the QAS 122 is coupled to information sources 130. The information sources 130 include numerous sources of data that can be used for research. The information sources 130 can include websites or servers owned or administered by news outlets (e.g., Associated Press, Bloomberg, CNBC, CNN, CSPAN, MSNBC, Fox Business, Fox News, Politico, Reuters, Wall Street Journal, Yahoo!) providing, for example, general news related to current national and world events, financial news, political news, or any other type of news.

The information sources 130 can also include financial data vendors (e.g., Interactive Data Corporation, Bloomberg, Standard & Poor's) and related services providing real time and historical financial market data related to investment vehicles (e.g., stocks, bonds, funds, options, futures, currencies).

The information sources 130 can further include social media sources and platforms, including but not limited to social networking sites (e.g., Facebook, LinkedIn, Twitter, Google+), blogs, photos (e.g., Instagram), location services sites (e.g., Foursquare), and other types of social media data sources. The data received from social media sources can be in the form of social media interactions (e.g., ‘likes’, ‘tweets’, ‘posts’, ‘follows’). The incoming social media data is commonly associated with companies (e.g., corporations and other business entities). In some embodiments, the incoming social media data is associated with other types of organizations. It should be appreciated that the system can receive social media data from any number of different types of entities that utilize social networks.

The various examples of the information sources 130 described above can comprise numerous external resources such as other computing devices, networks, databases, and the like, which provide inbound data feeds to the QAS 122. For example, the QAS 122 can receive news articles (e.g., financial, general, political, world), research reports, securities pricing information, and other research data via a Rich Site Summary (“RSS”) feed (e.g., http://www.bloomberg.com/feed/podcast/etf-report.xml, http://edition.cnn.com/services/rss/, http://www.rsssearchhub.com/feeds/c-span-feeds/). Alternatively, the QAS 122 can retrieve research data by accessing a database of news articles administered by a news outlet or via the news outlet website or server.

The QAS 122 ingests or retrieves research data from the information sources 130 on a real time basis. For example, the research data ingest module 128a ingests research data from information sources 130 over one or more RSS feeds that make research data available as soon as it is published. In another example, the module 128a periodically receives a research data aggregation file from the information sources 130 including one or more items of research data. Further, the research data retrieval module 128b can retrieve research data by periodically accessing a database of news articles administered by a news outlet or via the news outlet website or server.

The research data ingest module 128a and research data retrieval module 128b can each include a parsing function (e.g., Datasift platform) for processing (e.g., filtering, metadata extracting, text extracting, metadata tagging, categorizing, validating) the incoming research data and storing it in a formatted data structure for analysis by the research analytics module 128c. For example, news articles may include metadata (e.g., title, publication date, author's name) that can be extracted and stored in the data structure for improved processing by the module 128c.

Both the VRA 102 and the QAS 122 are coupled to a proprietary information store 120. The proprietary information store 120 can be a database, data store, disk array, or other server computing device external to the VRA 102 and the QAS 122. In some embodiments, the proprietary information store 120 comprises information that is stored locally on the VRA 102 and the QAS 122.

The proprietary information store 120 can include various information (e.g., fund prospectuses, historical pricing data, financial research opinions, articles, information about products and services offered by the financial services institution) that has been generated by, or is proprietary to, a financial services institution. Some or all of the information stored in the proprietary information store 120 may not be publically available, or may only be available to customers (e.g., individual investors, financial advisors, institutional investors) of the financial services institution.

The proprietary information store 120 can also include user profile data associated with an account owner of one or more financial accounts. For example, the proprietary information store 120 can include user profile data comprising data related to the account owner and the account owner's portfolio (e.g., personally identifiable information about the account owner and/or the account owner's spouse and dependents, account numbers and names of institutions at which accounts are held, an investment portfolio type, financial account position data such as holdings and quantity held, a customer service level assigned to the account owner's account such as Gold, Silver, or Bronze). The proprietary information store 120 can further include user profile data comprising information about the account owner's investment preferences (e.g., an investment goal, a risk tolerance rating, an investment type preference indication, an area of interest). In some embodiments, the user profile data stored on the proprietary information store 120 is only accessible to the VRA 102. In some embodiments, the user profile data is stored locally on the VRA 102.

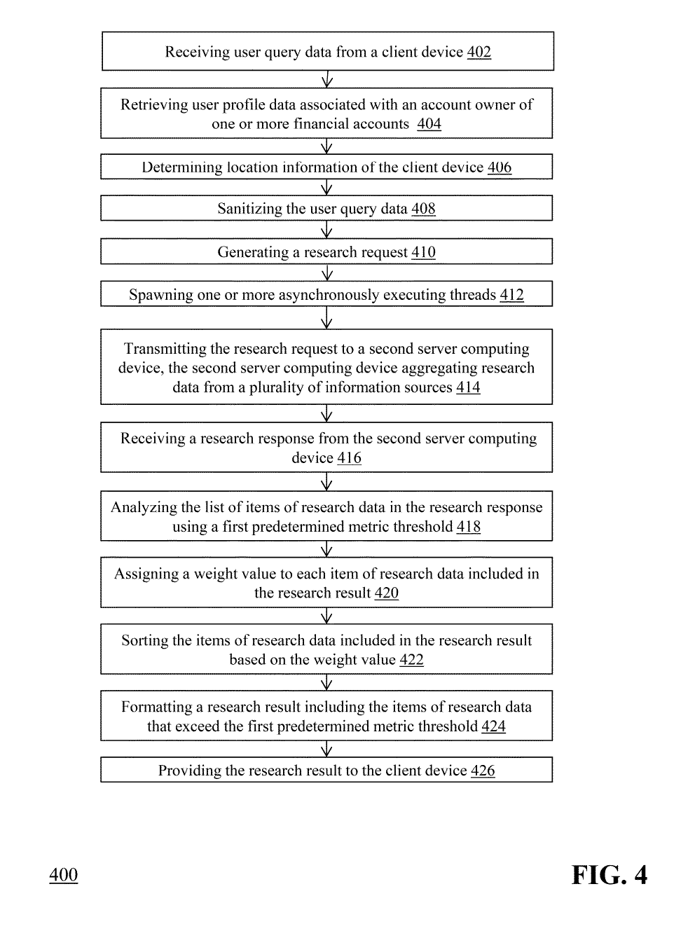

FIG. 4 is a flow diagram of a method 400 for providing a research result tailored to user profile data of an account owner, using the system 100 depicted in FIG. 1. A user 104 operating a client device 106 accesses the VRA 102 utilizing client access 112. The identity of the user 104 can be established by a log in and authentication process facilitated by the user profile module 108a.

Upon successful log in and authentication of the user 104, a research session is established between the client device 106 and the VRA 102. The VRA 102 receives (402) user query data from the client device 106. The request generation module 108c receives the user query data related to a research topic associated with one or more financial accounts or investment preferences of an account owner. In some embodiments, the module 108c stores the user query data to database 110 for later processing by one or more modules 108. In some embodiments, the module 108c spawns a first processing thread for receiving the user query data and storing it to the database 110, and an additional processing thread executing asynchronously from the first thread for retrieving the user query data from the database 110 and processing it according to the method described herein.

The user query data can be in the form of a completely-formed sentence or sentence fragments, and may include a question or a statement. The user query data can also be a group of key words related to the chosen research topic. In some embodiments, the user query data is a hyperlink to a news article for which the account owner wants to get related research.

The user query data can be a factual inquiry requesting data that can readily be determined based on data available in the proprietary information store 120 and/or the information sources 130. For example, “What is the current price of XYZ Corporation's stock?” or, “What is the current value of my investment portfolio?”

The user query data can further be an open-ended or general inquiry which may require analysis or interpretation of data available in the proprietary information store 120 and/or the information sources 130. For example, “Does the news in Russia affect my investment portfolio?” or, “What mutual funds would help me achieve my goal of saving for my child's college tuition?”

The VRA 102 retrieves (404) user profile data associated with an account owner of one or more financial accounts. The user profile module 108a retrieves user profile data from the proprietary data store 120 and stores it for later processing by the request generation module 108c.

The VRA 102 determines (406) a location of the client device 106 based on one or more of global positioning system (“GPS”) coordinates provided by a mobile device, an internet protocol (“IP”) address of the client device 106, radiolocation information from a cellular network used by the client device 106, and physical location data obtained from a positioning system in communication with the client device. The location detection module 108b determines the location of the client device 106 and stores the location information for later processing by the request generation module 108c. The location detection module 108b determines the location of the client device 106 based on information it receives from the client device 106, or information associated with its communication with the client device 106 over network 114. In another example, the location of the client device 106 is determined based on data that has been obtained from an indoor or outdoor positioning system the client device 106 is in communication with. In some embodiments, the client device 106 receives a unique identifier wirelessly from a positioning system in nearby proximity and determines its physical location based on a lookup of the unique identifier at a database or server accessible via a computer network (e.g., communications network 114, internet). In some embodiments, the location of the client device 106 can be determined based on data obtained from an indoor or outdoor positioning system utilizing magnetic positioning, inertial measurements (e.g., dead reckoning), triangulation, or any other wireless location technology known in the art.

In one example, the client device 106 is a GPS-enabled mobile device or a computing device having a GPS receiver, and the location detection module 108b determines the location of the client device 106 based on GPS coordinate data provided by the client device 106. The module 108b can also determine a time of day that the client device 106 is at a location, and a duration of time that the client device 106 remains at a location. In another example, the module 108b can determine the location of the client device 106 based on geolocation-mapping of an IP or network address of the client device 106 that the module 108b extracts from network data packets transmitted by the client device 106 to the VRA 102 over network 114. In another example, the module 108b can determine the location of the client device 106 based on radiolocation information from a cellular network used by the client device 106 that the module 108b extracts from network data packets transmitted by the client device 106 to the VRA 102 over network 114.

The VRA 102 sanitizes (408) the user query data before generating a research request. The request generation module 108c can sanitize the user query data if necessary to anonymize the research request. For example, if the VRA 102 and the QAS 122 communicate over an unsecured or untrusted network, or if the QAS 122 is owned and administered by a different entity than the VRA 102, the module 108c can remove confidential information (e.g., a financial account number, personally identifiable information of the account owner) that may have been provided in the user query data. In one embodiment, the module 108c determines if the user query data requires sanitization by comparing the terms of the user query data to user profile data and determining if the terms that match are confidential information that should be removed before generating and transmitting a research request. In one embodiment, an element (e.g., variable, field, flag) assigned to the confidential data in the user profile data indicates to the module 108c that the data is confidential and should be removed during sanitization of the user query data.

The VRA 102 generates (410) a research request based on the user profile data and the user query data. As described above, the request generation module 108c receives user query data from the client device 106. The module 108c further receives the account owner's user profile data from the user profile module 108a. The module 108c processes the user query data and user profile data and generates a research request which includes research query data based on the user query data and user profile data.

In some embodiments, the module 108c creates the research query data for the research request by modifying or supplementing the user query data based on the account owner's user profile data. By having the capability to supplement the user query data with relevant contextual information from the account owner's user profile data, the VRA 102 can effectively customize the research system 100 to any account owner's investment portfolio and/or investment preferences and therefore provide more useful and meaningful research results tailored to an account owner. The resulting context-integrated research request that is generated improves the research process by reducing the number of CPU transactions required to return useful and meaningful research results and likewise reducing the consumption of network bandwidth and resources required to conduct research. For example, the VRA 102 can generate a research request that is detailed enough for the QAS 122 to return a research result with meaningful items of research data without requiring numerous CPU-intensive interactions between the client device 106, the VRA 102, the QAS 122, and all intervening network devices facilitating communication between the components of research system 100.

The concept may best be understood by way of an example. As described above, the module 108c can sanitize the user query data to remove personally identifiable information that may have been provided. In some embodiments, the module 108c generates the research query data by supplementing the sanitized user query data with data from the account owner's user profile data. In this example, the user 104 is an RIA using system 100 to conduct research for an account owner of one or more financial accounts. The RIA has an inquiry related to the performance of a specific financial account that has recently dropped in value, and provides the user query data, “Why is John Smith's ABC Investments account number 123-456789 down this month?” via client device 106.

In this example, the account owner's name, “John Smith,” and the account information, “ABC Investments account number 123-456789,” are confidential information that the request generation module 108c removes during sanitization. However, after sanitization, the user query data remaining (e.g., “Why is down this month?”) may be too vague for the QAS 122 to identify meaningful research results. Based on the account owner's account information in the user profile data, the module 108c can create research query data for the research request by supplementing the user query data to include, for example, the ticker symbols for all of the holdings in the account identified in the user query data. For example, if John Smith's ABC Investments account number 123-456789 includes holdings in XYZ Corporation stock and a mutual fund administered by ABC Investments, the module 108c can supplement the user query data with the ticker symbols for the two holdings (e.g., XYZ and ABCGX), resulting in the research query data, “Why is XYZ and ABCGX down this month?” In this example, despite not being grammatically correct, the resulting research query data generated based on the user query data and the user profile data is likely specific enough for the QAS 122 to identify items of research data discussing XYZ and ABCGX relevant to the inquiry.

In some embodiments, the request generation module 108c includes a natural language processing engine capable of interpreting sentences, phrases, or strings of keywords provided in the user query data based on predetermined statistical models. For example, the module 108c can use a natural language processing engine to identify a desired research activity based on commonly-used language, and supplement the user query data accordingly with data from the user profile data.

In some embodiments, the module 108c generates the research request further based on the location of the client device 106. As described above, GPS 112e client can provide location and time information about the client device 106 to the VRA 102. In some embodiments, the time information can be used to determine the duration of time the client device 106 has remained at a particular location. In some embodiments, the location information is a closest identifiable address to the client device 106.

The module 108c can supplement the research query data based on the location and/or time information received from GPS client 112e.

In one example, the user 104 is an account owner using system 100 to conduct research related to a business in his area. In this example, the account owner arrives at his favorite retail chain store, XYZ-Mart, and discovers that it has closed its doors. The account owner interacts with the VRA 102 by way of a GPS-enabled client device 106 (e.g., smart phone) utilizing client access application 112a which includes GPS client 112e. The client device 106 is used to provide the user query data, “What happened to XYZ-Mart?” to the VRA 102. The module 108c analyzes the user query data based on the user profile data, but there is no relevant user profile data with which to supplement the user query data. Accordingly, the resulting research query data is identical to the user query data provided by the client device 106 (e.g., “What happened to XYZ-Mart?”).

In this example, GPS client 112e provides the location information of the client device 106 to the VRA 102, and the module 108c supplements the research query data with the location information. For example, based on the addition of the location information, the research query data can be, “What happened to XYZ-Mart at 100 Main St. Boston, Mass., 02110?” The integration of the location information with the research query data provides additional context to the research request and allows the QAS 122 to provide more useful and meaningful research results. For example, if XYZ-Mart is a large national retail chain, the research results returned based on the inquiry without the location information may only include information (e.g., news, finance reports) related to the operation of the company at the corporate level with little related to individual stores. In contrast, the context-based query integrating location information can identify a local news article written specifically about the closing of the XYZ-Mart frequented by the account owner or narrow the research related to XYZ-Mart to articles discussing XYZ-Mart within a region (e.g., Boston area).

In some embodiments, the module 108c generates the research query data based on one or more of the user query data, the user profile data, location information related to the client device 106, and time information related to the client device 106. The module 108c generates a research request including the research query data in a format compatible with API 118.

In some embodiments, the VRA 102 spawns (412) a first thread configured to store the research request to the database 110, and a second thread configured to transmit the research request to the second server computing, receive the research response from the second server computing device, and store the research response received from the second server computing device to the database, wherein the first thread and the second thread execute asynchronously. In some embodiments, API 116 and API 118 are based on a REST architecture, and updates related to research requests, research responses, and research results (e.g., generating a research request, transmitting a research request, receiving a research response) are made to the database 110 coupled to the VRA 102 and QAS 122. For example, the module 108c spawns a first thread configured to store the research request to the database 110, and an additional thread configured to execute asynchronously from the first thread and transmit the research request to the QAS 122, receive the research response from the QAS 122, and store the research response to the database 110. When the research response is stored in the database 110, a subsequently-spawned thread can claim the research response for further processing by the response analysis module 108d. This asynchronous threading method keeps the module 108c free to serve other incoming requests without being blocked by the response analysis module 108d.

The VRA 102 transmits (414) the research request to the QAS 122, the QAS 122 aggregating research data ingested or retrieved from a plurality of information sources 130. The request generation module 108c generates the research request to conform to API 118 and transmits the research request to QAS 122. A communications network such as the communications network described with respect to communications network 114 can be used to facilitate transmission of the research request from the VRA 102 to the QAS 122. As described above, the QAS 122 aggregates real time and historical (e.g., time-series) research data that it ingests or retrieves from a plurality of information sources 130.

The QAS 122 receives the research request and the research analytics module 128c processes the research query data included in the research request. The module 128c can identify items of research data to include in a research response using a number of analytical techniques. In some embodiments in which the QAS 122 includes artificially intelligent, conversation cognitive computing technology such as Watson Discovery Advisor, the module 128c parses the research query data into keywords and sentence fragments and simultaneously executes numerous language analysis algorithms to determine statistically related phrases in the parsed research query data and the research data it has ingested and retrieved from the information sources 130 or research data from the proprietary information store 120. In some embodiments in which the QAS 122 employs a computational engine such as the Wolfram Alpha answer engine, the module 128c parses the research query data into keywords and sentence fragments and executes numerous computer algebra, symbolic and numerical computation, visualization, and statistics capabilities algorithms to identify a correspondence between phrases in the parsed research data and datasets obtained from the research data it has ingested, curated, and ordered from the information sources 130. In some embodiments, the module 128c can employ text-indexing techniques known in the art to index the research query data and research data ingested from the information sources 130 or research data from the proprietary information store 120, and can further utilize a semantic search or other search engine (e.g., Apache Solr, Google) to identify relevant research data.

The module 128c identifies items of research data to include in the research response as described above, and the response generation module 128d formats the research response to comply with API 118. The QAS 122 transmits the research response including the identified items of research data to the VRA 102.

The VRA 102 receives (416) the research response from the QAS 122, the research response including a list of items of research data corresponding to the research request, and a confidence rating associated with each item of research data. The response analysis module 108d receives the research response which includes a list of items of research data that the QAS 122 has identified based on the aforementioned analysis of the research query data from the research request.

Items of research data can include, for example, news articles, journal articles, market data related to an investment vehicle (e.g., price and trade-related data, ticker information), blog posts, tweets, and various other published or electronically posted information. In some embodiments, the items of research data include a natural language sentence, a phrase, or a number providing an answer corresponding to inquiry of the research query data.

In some embodiments, the list of items of research data is a digest providing an abstract or brief synopsis of each item of research data. In some embodiments, each item of research data is a full text article or document. In some embodiments the list of items of research data comprises hyperlinks to items of research data. In some embodiments, the list of items of research data includes data related to each item of research data (e.g., metadata). For example, the data related to each item of research data can include author name, publication date, publication volume and issue, an identifier (e.g., name, alphanumeric code, website address) of the information source from which the item of research data was ingested, and various other information. In some embodiments, the data related to each item of research data includes a data structure (e.g., array, lookup table, indexed list) comprising an identifier for each investment vehicle discussed in the item of research data and a corresponding impact indication. For example, the impact indication for each investment can include one or more elements (e.g., variable, field, flag) indicating whether the impact to the investment vehicle is predicted or realized, and whether the impact is an increase in a value, a decrease in a value, or a substantially unchanging value of the investment vehicle. In some embodiments, the data related an item of research data includes an indication of an impact to a business sector.

The list of items of research data corresponding to the research request also includes a confidence rating associated with each item of research data. The confidence rating can be expressed as a percentage value (e.g., a number or ratio expressed as a fraction of 100). In some embodiments, the confidence rating is expressed as a fractional number in the range of 0.00 to 1.00. In some embodiments, the confidence rating is expressed a whole number in the range of 0 to 100.

The confidence rating is calculated by the research analytics module 128c of the QAS 122 and can provide an indication of how likely the associated item of research data includes the information sought by the research request. In general, a higher confidence rating (e.g., a greater fractional or whole number value) indicates a greater calculated likelihood that the associated item of research data includes the information sought by the research request. In some embodiments, the confidence rating is based on how closely the research query data is statistically related to phrases, keywords, and other data in the item of research data or whether the QAS 122 was able to provide research data in response to a factual query.

The VRA 102 analyzes (418) the list of items of research data in the research response using a first predetermined metric threshold, the first predetermined metric threshold based on at least the confidence rating associated with each item of research data, and a predetermined reliability rating of the information source associated with each item of research data.

In some embodiments, a tier value (e.g., a predetermined reliability rating) has been assigned to each of the information sources 130 from which the QAS 122 ingests or retrieves research data. For example, the tier value can be assigned at the time an information source is coupled to the QAS 122, and stored in a data structure accessible to the VRA 102. In some embodiments, the database 110 includes a data structure comprising an identifier (e.g., name, alphanumeric code, website address) for each information source and the tier value associated with the information source.

In some embodiments, the tier value is a whole number in the range of 0 to 4, with a tier value of 0 being the highest reliability rating, and a tier value of 4 being the lowest reliability rating. It should be appreciated that any number of tier values can be used without departing from the scope of the invention, and further, that alternative tier assignment schemes (e.g., the largest tier value being the highest reliability rating) can likewise be used without departing from the scope of the invention.

The tier value assigned to an information source can be based on various factors indicative of reliability. In some embodiments, the tier value can be based on whether or not the information source is an accredited news outlet and/or whether the items of research data provided by the information source are subject to an editing and quality assurance process. In some embodiments, the tier value can be based on whether the information source is a financial news outlet, a general news outlet, a world news outlet, or a political news outlet. For example, a financial news outlet may be assigned a tier value indicating a higher reliability than a political news outlet not because the political new outlet is considered unreliable from a credibility standpoint, but rather because the financial news outlet is more likely to publish items of research data relevant to financial research topics that are the subject of financial research inquiries. In some embodiments, the tier value can be based on the reputation of the information source and the authors of its research data for providing reliable data. In some embodiments, the tier value can be based on the reputation of the information source for providing biased or unbiased research data. In some embodiments, the tier value can be based on whether or not the data provided by the information source is subject to government regulations (e.g., SEC, IRS) on data accuracy.

In some embodiments, social media sources can be assigned a unique tier value reserved for the information sources that are social media sources. Generally, the posts, tweets, photos, and other data provided by social media sources are considered to be the lowest reliability research data because they are generally not edited and can be posted by anyone in the general public. Further, they are often not related to topics of financial research.

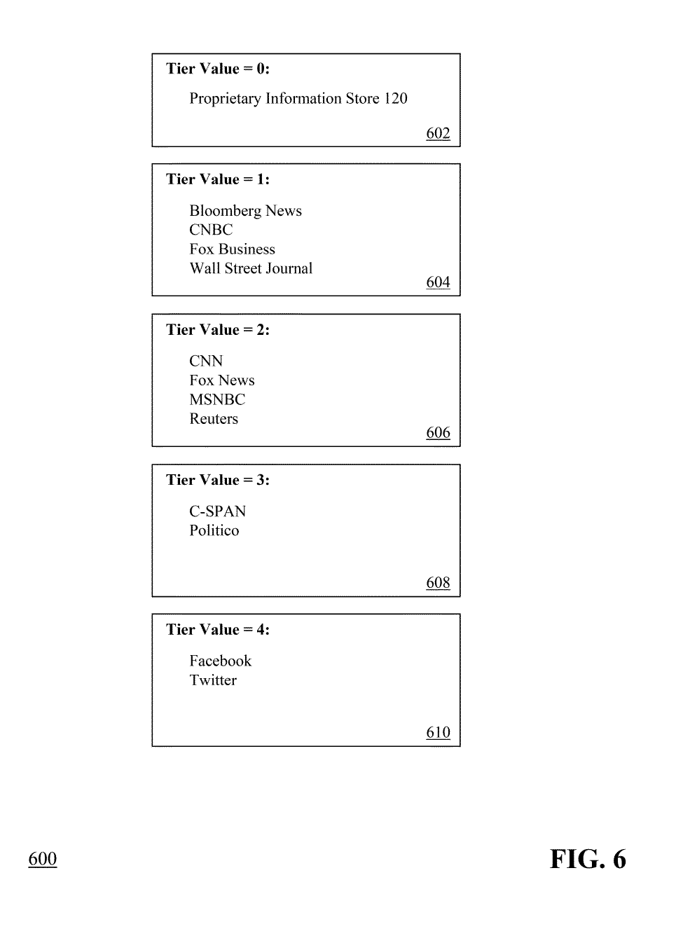

FIG. 6 provides one example of a tier value assignment 600 for various exemplary information sources. In this example, a tier value of 0 indicates the highest predetermined reliability rating, and a tier value of 4 indicates the lowest predetermined reliability rating. As shown in FIG. 6, a tier value of 0 (602) is assigned to the proprietary information store 120. As described above, the proprietary information store 120 can be one of the information sources from which the QAS 122 ingests or retrieves research data. In this example, the proprietary information store 120 is assigned to the tier with the highest predefined reliability rating because it includes research data generated by or proprietary to the financial services institution that controls the system 100. A tier value of 1 (604) is assigned to exemplary information sources that primarily focus on reporting financial news (e.g., Bloomberg News, CNBC, Fox Business, Wall Street Journal). A tier value of 2 (606) is assigned to exemplary information sources that primarily focus on more general news reporting (e.g., CNN, Fox News, MSNBC, Reuters). A tier value of 3 (608) is assigned to exemplary information sources that primarily focus on reporting political news (e.g., C-SPAN, Politico). A tier value of 4 (610) is assigned to exemplary social media information sources (e.g., Facebook, Twitter).

Returning to FIG. 4 (418), the response analysis module 108d analyzes the list of items of research data in the research response to determine which items of research data exceed the first predetermined metric threshold. The module 108d analyzes each item of research data in the research response by comparing the confidence rating associated with each item of research data and the tier value of the information source associated with each item of research data to the first predetermined metric threshold. The first predetermined metric threshold can be based on, at least, the confidence rating associated with each item of research data, and a tier value (e.g., a predetermined reliability rating) of the information source associated with each item of research data.

Building on the example in FIG. 6, in one embodiment, an item of research data from a tier 0 (high predetermined reliability rating) information source exceeds the first predetermined metric threshold when the confidence rating associated with the item of research data is greater than 50%. However, an item of research data from a lower reliability tier can exceed the first predetermined metric threshold only when the confidence rating associated with the item of research data is greater than 50% (e.g., 60% for tier 1 information sources, 70% for tier 2 information sources, 80% for tier 3 information sources, and 90% for tier 4 social media information sources). The predetermined confidence rating thresholds associated with each tier are provided as examples and are not exhaustive or limiting. Other values can be chosen without departing from the scope of the invention. In some embodiments, the user 104 can select the predetermined confidence rating thresholds associated with each tier value, or the predetermined confidence rating thresholds associated with each tier value can be part of the account owner's user profile data.

In some embodiments, the first predetermined metric threshold for items of research data from social media information sources can be based on, at least, the confidence rating associated with each item of research data, a predetermined reliability rating of the information source associated with each item of research, and a minimum recurrence count associated with the item of research data. For example, an item of research data provided from a social media source can also include an associated counter to count the recurrence of a social media activity. In one example, the counter associated with an item of research data indicates the number of re-tweets of the item of research data that have occurred. In another example, the counter associated with an item of research data indicates the number of likes the item of research data has received. In some embodiments, an item of research data from a social media information source exceeds the first predetermined metric threshold when the confidence rating associated with the item of research data is greater than 90% and the counter has reached at least 10,000 recurrences.

The response analysis module 108d determines which items of research data exceed the first predetermined metric threshold and stores those items of research data and their associated information from the research response in a data structure for processing by other modules 108 in the VRA 102. For example, the items of research data stored in the data structure can later be included in a research result formatted by the result format module 108e. In some embodiments, the data structure comprising the items of research data (and their associated information from the research response) is stored in the database 110 or in a storage medium local to the VRA 102.

In some embodiments, the VRA 102 assigns (420) a weight value to each item of research data included in the research result, the weight value calculated based on an impact to an investment vehicle discussed in at least one of the items of research data, wherein an impact is predicted or realized, and wherein an impact is further an increase in a value, a decrease in a value, or a substantially unchanging value, and a ratio of the value of the impacted investment vehicle in an investment portfolio owned by the account owner to the overall value of the investment portfolio owned by the account owner (e.g., ownership ratio).

In determining the weight value, the response analysis module 108d analyzes each item of research data and its associated metadata in conjunction with user profile data related to the account owner's investment portfolio. As described above, the research response from the QAS 122 can include a data structure comprising an identifier for each impacted investment vehicle that is discussed in a particular item of research data and a corresponding impact indication indicating whether the impact to the investment vehicle is predicted or realized, and whether the impact is an increase in a value, a decrease in a value, or a substantially unchanging value of the investment vehicle. The module 108d compares the data structure of impacted investment vehicles to the account owner's user profile data to determine if the account owner owns any of the impacted investment vehicles. In some embodiments, the module 108d first determines all of the individual investment vehicles that make up a fund (e.g., mutual fund) held in the account owner's investment portfolio. Using this information, the module 108d determines if the account owner owns any of the impacted investment vehicles.

Once the response analysis module 108d has determined which of the impacted investment vehicles is owned, either directly or indirectly (e.g., through a fund), by the account owner, the module 108d calculates a ratio for each impacted investment vehicle that is owned by the account owner. In some embodiments, the ratio is the value (e.g., monetary value) of the impacted investment vehicle owned by the account owner to the overall value (e.g., monetary value) of the account owner's investment portfolio.

In a first example, the module 108d identifies stock of ABC Corporation as an impacted investment vehicle, and determines that the account owner owns $5,000 worth of ABC Corporation's stock in an investment portfolio having an overall value of $50,000. In this first example, the ratio calculated by the module 108d for ABC Corporation (e.g., an impacted investment vehicle discussed in an item of research data) is $5,000 to $50,000 (e.g., 5,000/50,000), or 0.10.

In a second example, the module 108d once again identifies the stock of ABC Corporation as an impacted investment vehicle, and determines that the account owner owns $5,000 worth of XYZ fund, in which shares of ABC Corporation stock represent 10% of the fund's total value. In this second example, the ratio calculated by the module 108d takes into account the proportion of XYZ fund that is made up of ABC stock. In this example, for an investment portfolio having an overall value of $50,000, the ratio calculated by the module 108d is 10% of $5,000 to $50,000 (e.g., 500/50,000), or 0.01.

Generally, a higher ratio indicates that the impacted investment vehicle discussed in the item of research data represents a larger portion of the overall value of the account owner's investment portfolio. Accordingly, the ratio can indicate the share (e.g., percentage) of the account owner's investment portfolio that is impacted based on the one or more impacted investment vehicles discussed in the item of research data.

The module 108d calculates a weight value for each item of research data included in the research response based on the data related to impacted investment vehicles and the ratio(s) calculated as described above, and assigns a weight value to each item of research data. In some embodiments, the weight value assigned to an item of research data is the sum of the ratios that the module 108d calculates for each impacted investment vehicle discussed in the item of research data. In some embodiments, the first predetermined metric threshold is further based on the weight value calculated as described above. In some embodiments, the weight value for each item of research data is multiplied by a predetermined coefficient according to the tier value of the information source from which the item of research data was ingested or retrieved.

In some embodiments, the VRA 102 further assigns (420) a second weight value to each item of research data included in the research result, the second weight value calculated based on one or more of a publication date of the item of research data and a volume of items of research data included in the research response that discuss the same impacted investment vehicle.

In determining the second weight value, the response analysis module 108d analyzes each item of research data and its metadata. As described above, the metadata related to each item of research data can include the publication date of the item of research data. It can be useful to know an age or “staleness” of the items of research data provided in the research response. In many cases, the items of research data that are the most current are the most desirable. In some embodiments, the module 108d determines the staleness of each item of research data. For example, the module 108d can calculate a difference (e.g., number of hours, days, months) between the publication date of each item of research data in the research response and the current date or the date the research request was submitted. In some embodiments, the second weight value is a numerical staleness indication equal to the reciprocal of the calculated difference between the publication date of the item of research data and the current date or the date the research request was submitted. In some embodiments, the second weight value assigned to an item of research data is a whole number equal to the calculated difference between the publication date of the item of research data and the current date or the date the research request was submitted. In some embodiments, the calculated second weight value for each item of research data is multiplied by a predetermined coefficient according to the information source from which the item of research data was ingested or retrieved. For example, an item of research data from an information source providing ticker information can be out of date and stale in a matter of minutes, whereas a prospectus for a mutual fund may stay current and useful for months.

As described above, the module 108d can determine which investment vehicles discussed in a particular item of research data are impacted investment vehicles. In determining the second weight value, the module 108d can further determine a volume of items of research data included in the research response that discuss the same impacted investment vehicle. In some embodiments, the module 108d calculates a second weight value according to a ratio of the items of research data in the research response that discuss the same investment vehicle to the total number of items of research data in the research response. By way of example, for a research result in which six items of research data out of a total of ten discuss an impact to the stock of ABC Corporation, the module 108d can assign a second weight value of 6 to 10 (e.g., 6/10), or 0.60 to the items of research data in the research response that discuss the same impacted investment vehicle.

The second weight value assigned to each item of research data by the module 108d can be based on one or more of the calculations discussed above. In some embodiments, the second weight value assigned to an item of research data is a function of both a numerical staleness indication and a ratio of the items of research data that discuss the same investment vehicle to the total number of items of research data in the research response. In some embodiments, the first predetermined metric threshold is further based on the second weight value calculated as described above.

In some embodiments, the module 108e sorts (422) the items of research data included in the research result based on one or more of the first weight value and the second weight value assigned to each item of research data as discussed above. For example, the module 108e can sort the items of research data hierarchically (e.g., at a first level according to the first weight value and at a second level according to the second weight value). In some embodiments, the module 108e sorts the list of items of research data provided in the research result according to the one or more of the predetermined reliability rating associated with each item of research data and the confidence rating associated with each item of research data.

The VRA 102 formats (424) a research result including the items of research data that exceed the first predetermined metric threshold. The result format module 108e generates a list of items of research data including the list of items of research data that exceed the first predetermined metric threshold in the data structure stored by the response analysis module 108d. The module 108e processes each item of research data in the data structure to determine what investment vehicles are discussed in the item of research data, and further to determine the ticker symbol associated with those investment vehicles. Based on this information, the module 108e also generates a list of one or more ticker symbols for investment vehicles discussed in the items of research data that exceed the first predetermined metric threshold. In some embodiments, the ticker symbols for investment vehicles discussed in each item of research data are provided as metadata in the research response.

In some embodiments, the research result formatted by the VRA 102 comprises one or more of a list of hyperlinks, a digest of items of research data that are above the first predetermined metric threshold, and the confidence rating associated with each item of research data that exceeds the first predetermined metric threshold. In one example, the list of hyperlinks includes a hyperlink for accessing each item of research data in the research result at a website corresponding to the information source from which the item of research data was ingested or retrieved.

In some embodiments, the display format of the research result depends on the client device 106 to which the research result is transmitted. For example, a research result transmitted to a client device 106 having a display with a large viewing area (e.g., personal computer, laptop) can display more content (e.g., graphics, charts, hyperlinks, full text, digests) corresponding to each item of research data than a client device 106 having a display with a smaller viewing area (e.g., smartphone, smart watch).

The VRA 102 provides (426) the research result to the client device 106. The result format module 108e formats the research result to comply with API 118 and provides the research result to the client device 106. The module 108e can also store the research result in the database 110 or in a storage medium local to the VRA 102. In some embodiments, the research result and the corresponding research request on which it was based are added to the user profile data associated with the account owner of the one or more financial accounts. In some embodiments, the user profile data comprises a list of prior research requests associated with the account owner and a list of prior research results associated with the account owner. In some embodiments, the prior research requests and/or research responses can be used to generate subsequent research requests.

In some embodiments, the original research session that was established to provide the user query data to the VRA 102 from the client device 106 is still active, and the research result is provided to the client access 112 being utilized by the client device 106. In this example, the research result is immediately displayed on the client device 106. In some embodiments, a research session is no longer active when the research result has been formatted, and the research result is provided to the client device 106 as an attachment to an email. In some embodiments, the VRA 102 provides an alert (e.g., email, text message) to indicate that the research result is ready to be accessed by the client device 106. In some embodiments, the VRA 102 provides the research result to multiple client devices 106. In some embodiments in which the user 104 is not the account owner of the one or more financial accounts, the VRA 102 can provide the research result to a client device 106 or email address associated with the user 104, and to a client device 106 or email address associated with the account owner.

In some embodiments, the VRA 102 provides the research result to a second client device 106 that is different than the client device 106 that originally was used to submit the user query data. For example, the client device 106 used to submit the user query data can be a wearable computing and communications technology, and the user device 106 used to retrieve and display the research result can be a personal computer. It should be appreciated that an account owner can use any number of client devices 106 to interact with the VRA 102 without departing from the scope of the invention.

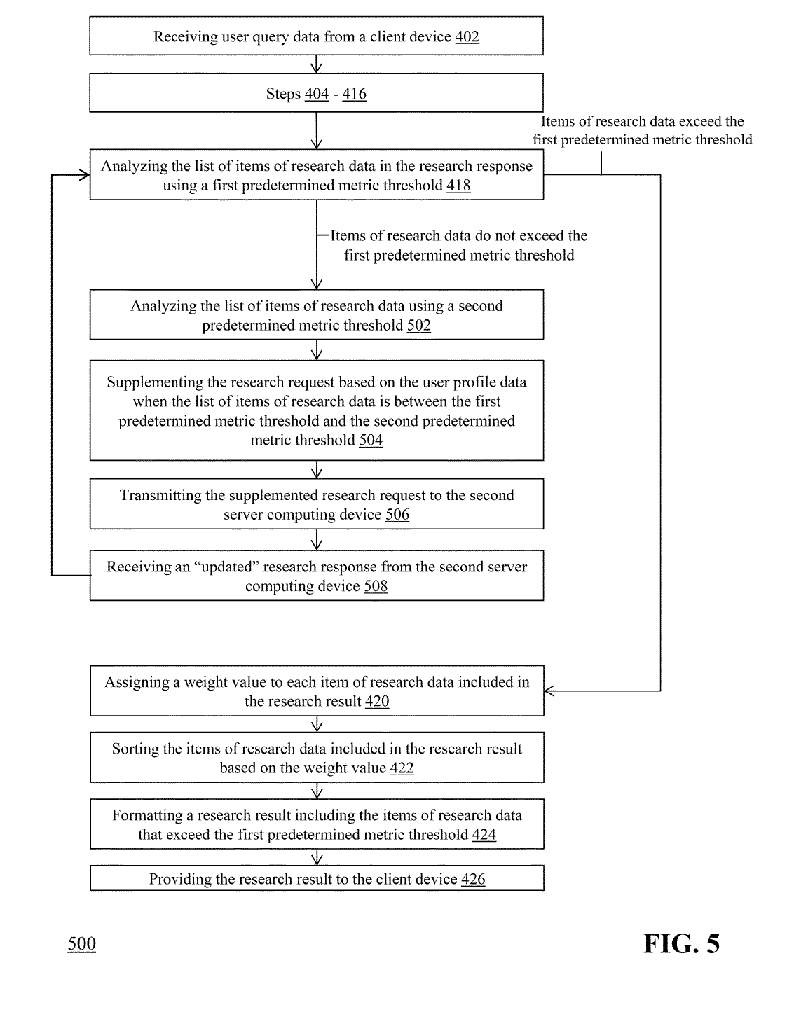

FIG. 5 is a flow diagram of a method 500 for providing a supplemented research result tailored to user profile data of an account owner, using the system 100 depicted in FIG. 1. As shown in FIG. 5, method 500 incorporates the method steps (402-426) of method 400, and includes additional method steps 502-508 between steps 418 and 420.

In some examples, VRA 102 analyzes (418) the list of items of research data in the research response using a first predetermined metric threshold and determines that none of the items of research data provided in the research response exceed the first predetermined metric threshold. For example, the research query data on which the research request was based can include an inquiry that is too general or vague for the analytical techniques utilized by the QAS 122 to identify items of research data from the information sources 130 that exceed the first predetermined metric threshold. In such an example, the VRA 102 analyzes (502) the list of items of research data using a second predetermined metric threshold, the second predetermined metric threshold based on, at least, the confidence rating associated with each item of research data, and the predetermined reliability rating of the information source associated with each item of research data.

Like the first predetermined metric threshold described above (FIG. 4, 418), the second predetermined metric threshold can be based on, at least, the confidence rating associated with each item of research data, and a tier value of the information source associated with each item of research data. In some embodiments, the second predetermined metric threshold comprises a confidence rating associated with each tier value (e.g., predetermined reliability rating) that is lower than the confidence rating associated with each tier value of the first predetermined metric threshold value.

Further building on the example in FIG. 6, in one embodiment, an item of research data from a tier 0 (high reliability rating) information source exceeds the second predetermined metric threshold when the confidence rating associated with the item of research data is greater than 20%. However, an item of research data from a lower reliability tier can exceed the second predetermined metric threshold only when the confidence rating associated with the item of research data is greater than 20% (e.g., 30% for tier 1 information sources, 40% for tier 2 information sources, 50% for tier 3 information sources, and 60% for tier 4 social media information sources). The predetermined confidence rating thresholds associated with each tier are provided as examples and are not exhaustive or limiting. Other values can be chosen without departing from the scope of the invention. In some embodiments, the user 104 can select the predetermined confidence rating thresholds associated with each tier value, or the predetermined confidence rating thresholds associated with each tier value can be part of the account owner's user profile data.

Like the first predetermined metric threshold described above (FIG. 4, 418), the second predetermined metric threshold for items of research data from social media information sources can be based on, at least, the confidence rating associated with each item of research data, a predetermined reliability rating of the information source associated with each item of research, and a minimum recurrence count associated with the item of research data. In some embodiments, an item of research data from a social media information source exceeds the second predetermined metric threshold when the confidence rating associated with the item of research data is greater than 60% and the counter has reached at least 5,000 recurrences.

Returning to FIG. 5, the response analysis module 108d determines which items of research data exceed the second predetermined metric threshold but do not exceed the first predetermined metric threshold (e.g., items of research data that are between the first predetermined metric threshold and the second predetermined metric threshold) and stores those items of research data and their associated information from the research response in a data structure for processing by other modules 108 in the VRA 102. For example, the items of research data stored in the data structure can be formatted into a research result by the result format module 108e. In some embodiments, the data structure comprising the items of research data (and their associated information from the research response) is stored in the database 110 or in a storage medium local to the VRA 102.

The VRA 102 supplements (504) the research request based on the user profile data when the list of items of research data is between the first predetermined metric threshold and the second predetermined metric threshold. By having the capability to supplement the research query data from the original research request with relevant contextual information from the account owner's user profile data, the VRA 102 can effectively customize the research system 100 to any account owner's investment portfolio and/or investment preferences and therefore provide more useful and meaningful research results tailored to an account owner. The resulting context-integrated research request that is generated improves the research process by reducing the number of CPU transactions required to return useful and meaningful research results and likewise reducing the consumption of network bandwidth and resources required to conduct research. For example, the VRA 102 can generate a supplemented research request that is detailed enough for the QAS 122 to return a research result with meaningful items of research data without requiring numerous CPU-intensive interactions between the client device 106, the VRA 102, the QAS 122, and all intervening network devices facilitating communication between the components of research system 100. In some embodiments, the request generation module 108c supplements the research request by appending additional sentences, sentence fragments, or keywords to the research query data from the original research request based on the account owner's user profile data. For example, the module 108c can supplement the research query data with keywords related to the account owner's investment preferences (e.g., an investment goal, a risk tolerance rating, an investment type preference indication, an area of interest).

In another example, the module 108c can analyze the user profile data to determine one or more investment vehicles held by the account owner that represent a majority of the monetary value of an account owner's investment portfolio, and supplement the research query data with an identifier (e.g., organization name, ticker symbol) for the one or more investment vehicles.

This concept can be illustrated by way of an example including two different account owners for which a research request has been generated based on the research query data, “Does the news in Russia affect my investment portfolio?”

In this example, the items of research data that the QAS 122 has recently ingested from information sources 130 include items of research data related to news in Russia. Some items of research data discuss the discovery of a new Russian oil reserve, and other items of research data discuss a depletion of Russia's iron ore that is expected to cripple steel production and steel exports. The research request generated based on the research query data, “Does the news in Russia affect my investment portfolio?” is too general, and the research response provided by the QAS 122 includes items of research data that are determined to be between the first predetermined metric threshold and the second predetermined metric threshold.

The first account owner in this example has an investment portfolio in which shares of stock in ABC Oil Company represent a majority of the portfolio's monetary value. The module 108c determines that ABC Oil Company represents a majority of the monetary value of the account owner's investment portfolio, and supplements the research query data accordingly to integrate relevant information from the first account owner's user profile data and add context to the research query data. The research query data on which a supplemented research request is based can be, “Given my ownership of shares of ABC Oil Company, does the news in Russia affect my investment portfolio?” With the additional context added to the research request, the QAS 122 can provide a research response including the items of research data discussing the discovery of the new oil reserve.

The second account owner in this example has an investment portfolio in which shares of stock in XYZ Iron and Steel Corporation represent a majority of the portfolio's monetary value. The module 108c determines that XYZ Iron and Steel Corporation represents a majority of the monetary value of the second account owner's investment portfolio, and supplements the research query data to integrate relevant information from the second account owner's user profile data and add context to the research query data. The research query data on which a supplemented research request is based can be, “Given my ownership of shares of XYZ Iron and Steel Corporation, does the news in Russia affect my investment portfolio?” With the additional context added to the research request, the QAS 122 can provide a research response including the items of research data discussing the depletion of Russia's iron ore that is expected to cripple steel production and steel exports.

In some embodiments, the research request generated based on the research query data is too vague or too general, and the QAS 122 provides a research response for which none of the items of research data exceed the first predetermined metric threshold or the second predetermined metric threshold.

In one example, a research request is generated based on the research query data, “What mutual funds would help me achieve my goal of saving for my child's college tuition?” In this example, the account owner's user profile data does not have any information related to the account owner's child (e.g., name, date of birth, expected enrollment date) or a savings goal for college tuition (e.g., desired amount of savings), so the module 108c is unable to integrate additional data from the account owner's user profile with the research query data to add sufficient context to the research request. As a result, the research request generated by the module 108c is too vague, and the research response provided by the QAS 122 includes items of research data for which none of the items of research data exceed the first predetermined metric threshold or the second predetermined metric threshold. In this example, the VRA 102 formats a research result including an indication that the research request submitted included research query data that was too vague or general, and prompting the user 104 for additional information or clarification of the user query data. The research result can be provided to the user device 106 in a substantially similar manner as described above in connection with FIG. 4, 426.

Once additional information (e.g., child's date of birth, child's expected enrollment date, target amount of savings) is received from the client device 106, the module 108c generates a supplemented research request integrating the additional information into the research query data. The additional information provided to supplement the research query data can also be added to the account owner's user profile data for use in supplementing and generating subsequent research requests.

The first server computing device transmits (506) the supplemented research request to the QAS 122. The module 108c generates a research request based on the supplemented research query data by a similar process to that described with respect to FIG. 4, 410. The supplemented research request is generated to conform to API 118 and is transmitted to the QAS 122 for processing.

The VRA 102 receives (508) a second (e.g., updated) research response from the QAS 122. In some embodiments, the second research response can be an updated research response including the list of items of research data with associated confidence ratings provided in the original research response appended with the items of research data that were subsequently identified by the QAS 122 based on the supplemented research request. In some embodiments, the second research response can be an updated research response including only the items of research data that were subsequently identified by the QAS 122 based on the supplemented research request.

Method 500 then returns to step 420 in which the VRA 102 analyzes the list of items of research data in the research response using a first predetermined metric threshold. In some embodiments, the response analysis module 108d determines which items of research data in the updated research response exceed the first predetermined metric threshold as described above, and proceeds to method step 422. In some embodiments, the module 108d can determine that none of the items of research data provided in the updated research response exceed the first predetermined metric threshold, in which case method 500 returns to step 502 for further analysis and possible generation of an additional supplemented research request.

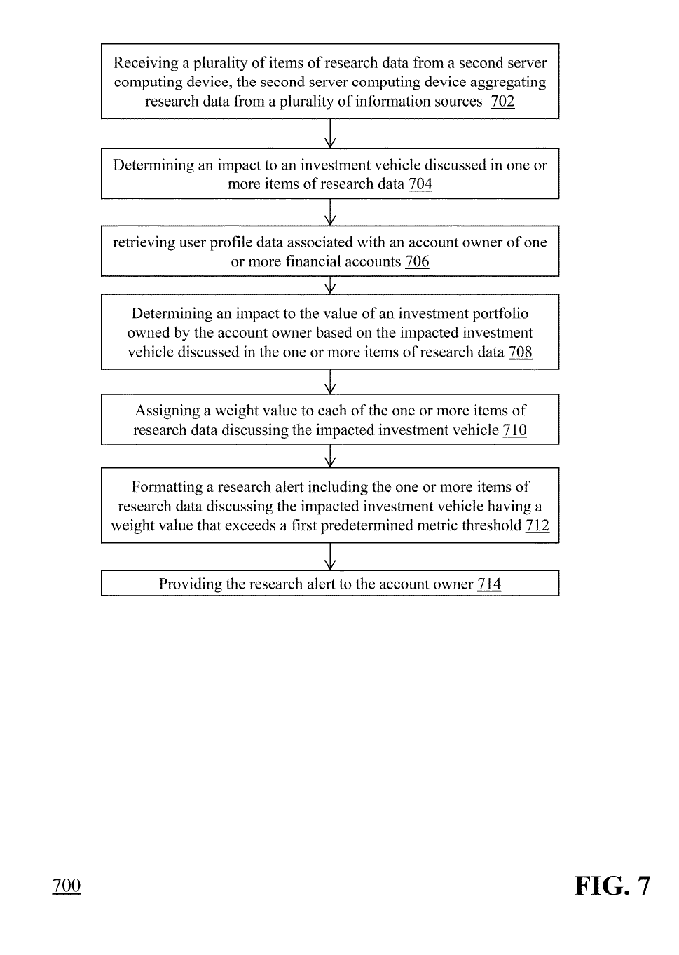

FIG. 7 is a flow diagram of a method 700 for providing a research alert tailored to user profile data of an account owner, using the system 100 depicted in FIG. 1. Using this method, a research alert can be generated and provided to an account owner based on analysis of the account owner's user profile data and the real time research data that the QAS 122 is continuously ingesting or retrieving.

The VRA 102 receives (702) a research response including a plurality of items of research data from the QAS 122, the QAS 122 aggregating research data from a plurality of real-time information sources.

As described above, the research data ingest module 128a and research data retrieval module 128b of the QAS 122 can ingest or retrieve research data from the information sources 130 on a real time basis. For example, the module 128a ingests research data from information sources 130 over one or more RSS feeds that make research data available as soon as it is published. In another example, the module 128a periodically receives a research data aggregation file from the information sources 130 including one or more items of research data. In another example, the research data retrieval module 128b retrieves research data by periodically accessing a database of news articles administered by a news outlet or via the news outlet website or server.

The research data ingest module 128a and research data retrieval module 128b can each include a parsing function (e.g., Datasift platform) for processing (e.g., filtering, metadata extracting, text extracting, metadata tagging, categorizing, validating) the incoming research data and storing it in a formatted data structure for analysis by the research analytics module 128c. For example, news articles may include metadata (e.g., title, publication date, author's name) that can be extracted and stored in the data structure for improved processing by the module 128c. As described above, the QAS 122 can also provide a data structure comprising an identifier for each impacted investment vehicle that is discussed in a particular item of research data and a corresponding impact indication indicating whether the impact to the investment vehicle is predicted or realized, and whether the impact is an increase in a value, a decrease in a value, or a substantially unchanging value of the investment vehicle.

The research data ingest module 128a and research data retrieval module 128b ingest or retrieve research data in real time from the information sources 130 and parse the research data as described above. The response generation module 128d can generate a research response including a plurality of the most recent items of research data ingested of retrieved by the QAS 122 and the metadata associate with each item of research data. The module 128d formats the research response to comply with API 118. In some embodiments, the research response is generated without having received a corresponding research request by the VRA 102.

In some embodiments, the module 128d generates a research response when a predetermined number of new items of research data have been ingested or retrieved. In one example, the module 128d generates a research response when it has ingested or retrieved 1000 new items of research data. In some embodiments, the module 128d generates a research response at predefined time intervals. In one example, the module 128d generates a research response every two hours including all the new items of research data that have been ingested or retrieved during that time.

In some embodiments, the module 128d generates a research response in response to a research request from the VRA 102. The research request can be generated by the request generation module 108c in a predetermined format according to API 118. In one example, the research request requests all items of research data that have been ingested or retrieved based on a time period (e.g., since the last research request, in the past hour, in the past day, in the past week). In another example, the research request requests a predetermined number of the most recent items of research data that have been ingested or retrieved (e.g., the 1000 most recently ingested or retrieved items of research data).

The VRA 102 determines (704) an impact to an investment vehicle discussed in one or more items of research data, wherein the impact is predicted or realized, and wherein the impact is further an increase in a value of the investment vehicle, a decrease in a value of the investment vehicle, or a substantially unchanging value of the investment vehicle. The response analysis module 108d analyzes the items of research data provided in the research response to determine if an impact to an investment vehicle is discussed in the item of research data. In some embodiments, the module 108d analyzes a data structure provided in the research report that includes an identifier for each impacted investment vehicle that is discussed in a particular item of research data and a corresponding impact indication indicating whether the impact to the investment vehicle is predicted or realized, and whether the impact is an increase in a value, a decrease in a value, or a substantially unchanging value of the investment vehicle. In some embodiments, the module 108d generates a data structure including a list of impacted investment vehicles and the one or more items of research data in which they are discussed. In some embodiments, the module 108d discards items of research data that do not discuss an impact to an investment vehicle.

The VRA 102 retrieves (706) user profile data associated with an account owner of one or more financial accounts. The user profile module 108a retrieves user profile data from the proprietary data store 120 for processing by the response analysis module 108d. In one embodiment, the user profile data is retrieved from a storage medium (e.g., volatile memory, non-volatile memory, hard disk) local to the VRA 102. In another embodiment, the user profile data is retrieved from the database 110.

The VRA 102 determines (708) an impact to the value of an investment portfolio owned by the account owner based on the impacted investment vehicle discussed in the one or more items of research data. The module 108d compares the data structure of impacted investment vehicles with user profile data corresponding to the investment vehicles held in the account owner's investment portfolio to determine if the account owner owns any of the impacted investment vehicles. In some embodiments, the module 108d determines all of the individual investment vehicles that make up a fund (e.g., mutual fund) held in the account owner's investment portfolio. Using this information, the module 108d compares the user profile data indicating which investment vehicles are held in the account owner's investment portfolio with the data structure of impacted investment vehicles to determine if the account owner owns any of the impacted investment vehicles.

Once the module 108d has determined which of the impacted investment vehicles is owned, either directly or indirectly (e.g., through a fund), by the account owner, the module 108d calculates a ratio for each impacted investment vehicle that is owned by the account owner. In some embodiments, the ratio is the value (e.g., monetary value) of the impacted investment vehicle owned by the account owner to the overall value (e.g., monetary value) of the account owner's investment portfolio.

In a first example, the module 108d identifies stock of ABC Corporation as an impacted investment vehicle, and determines that the account owner owns $5,000 worth of ABC Corporation's stock in an investment portfolio having an overall value of $50,000. In this first example, the ratio calculated by the module 108d for ABC Corporation (e.g., an impacted investment vehicle discussed in an item of research data) is $5,000 to $50,000 (e.g., 5,000/50,000), or 0.10.

In a second example, module 108d once again identifies the stock of ABC Corporation as an impacted investment vehicle, and determines that the account owner owns $5,000 worth of XYZ fund, in which shares of ABC Corporation stock represent 10% of the fund's total value. In this second example, the ratio calculated by the module 108d takes into account the proportion of XYZ fund that is made up of ABC stock. In this example, for an investment portfolio having an overall value of $50,000, the ratio calculated by the module 108d is 10% of $5,000 to $50,000 (e.g., 500/50,000), or 0.01.

Generally, a higher ratio indicates that the impacted investment vehicle discussed in the item of research data represents a larger portion of the overall value of the account owner's investment portfolio. Accordingly, the ratio can indicate the share (e.g., percentage) of the account owner's investment portfolio that is impacted based on the one or more impacted investment vehicles discussed in the item of research data.

The VRA 102 assigns (710) a weight value to each of the one or more items of research data discussing the impacted investment vehicle, the weight value being based on a predetermined reliability rating of the information source associated with each of the one or more items of research data discussing the impacted investment vehicle, and a ratio of the value of the impacted investment vehicle in the investment portfolio owned by the account owner to the overall value of the investment portfolio owned by the account owner.

In a substantially similar process to that described above (FIGS. 4-6), a tier value (e.g., a predetermined reliability rating) can be assigned to each of the information sources 130 from which the QAS 122 ingests or retrieves research data. In the example shown in FIG. 6, the tier value is a whole number in the range of 0 to 4, with a tier value of 0 being the highest reliability rating, and a tier value of 4 being the lowest reliability rating. It should be appreciated that any number of tier values can be used without departing from the scope of the invention, and further that alternative tier assignment schemes (e.g., the largest tier value being the highest reliability rating) can likewise be used without departing from the scope of the invention.

The module 108d assigns a weight value to each item of research data included in the research response based on one or more of the tier value associated with the information source from which the item of research data was ingested or retrieved, and the one or more ratios calculated as described above indicating the value of the impacted investment vehicle. In some embodiments, the weight value assigned to each item of research data comprises the tier value of the information source from which the item of research data was ingested or retrieved, and one or more ratios calculated for each impacted investment vehicle discussed in the item of research data. In some embodiments, the weight value assigned to each item of research data comprises the tier value of the information source from which the item of research data was ingested or retrieved, and the sum of the one or more ratios calculated for each impacted investment vehicle discussed in the item of research data. In some embodiments, a coefficient associated with each tier value is applied to the calculated ratios in a mathematical operation.

The VRA 102 formats (712) a research alert including the one or more items of research data discussing the impacted investment vehicle having a weight value that exceeds a first predetermined metric threshold. For each item of research data, the module 108d compares the assigned weight value to a first predetermined metric threshold. The first predetermined metric threshold can be based on, at least, the tier value (e.g., predetermined reliability rating) associated with each information source, and a threshold associated with the calculated ratios. As illustrated above, the calculated ratio can indicate the percentage of the account owner's investment portfolio that is impacted based on the one or more impacted investment vehicles discussed in the item of research data.

In one embodiment, an item of research data from a tier 0 (high predetermined reliability rating) information source exceeds the first predetermined metric threshold when the ratio is greater than 0.10 (e.g., 10% of the overall value of the account owner's investment portfolio is impacted based on the one or more impacted investment vehicles discussed in the item of research data). However, an item of research data from a lower reliability tier can exceed the first predetermined metric threshold only when the ratio calculated for the item of research data is greater than 0.10 (e.g., 0.20 for tier 1 information sources, 0.30 for tier 2 information sources, 0.40 for tier 3 information sources, and 0.50 for tier 4 social media information sources.

The ratio thresholds associated with each tier are provided as examples and are not exhaustive or limiting. Other values can be chosen without departing from the scope of the invention. In some embodiments, the user 104 can select the ratio thresholds associated with each tier value, or the ratio thresholds associated with each tier value can be part of the account owner's user profile data.

The result format module 108e generates a list of items of research data that exceed the first predetermined metric threshold to include in the research alert, and formats the research alert to comply with API 118. The module 108e can sort the items of research data based on the weight value assigned to each item of research data. In one embodiment, the items of research data are sorted first based on tier value and then based on the calculated ratio related to portfolio impact. In another embodiment, the items of research data are sorted according to the calculated ratio related to portfolio impact.

The VRA 102 provides (714) the research alert to the account owner. In some embodiments, the research alert is provided to the account owner as an attachment to an email associated with account owner. In some embodiments, the VRA 102 provides the account owner with a notification (e.g., email, text message) indicating that a research alert is available to be accessed by a client device 106. In some embodiments, the VRA 102 provides the research alert to multiple individuals (e.g., account owner, RIA working with account owner).

The module 108e can also store the research alert in the database 110 or in a storage medium local to the VRA 102. In some embodiments, the research alert is added to the user profile data associated with the account owner of the one or more financial accounts.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, both general and special purpose microprocessors, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computer in communication with a display device, e.g., a CRT (cathode ray tube), plasma, or LCD (liquid crystal display) monitor, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein.

What is claimed is:

1. A computerized method for providing a research result tailored to user profile data of an account owner, the method comprising:
receiving, by a first server computing device, user query data from a client device;
retrieving, by the first server computing device, user profile data associated with an account owner of one or more financial accounts;
generating, by the first server computing device, a research request based on the user profile data and the user query data;
transmitting, by the first server computing device, the research request to a second server computing device, the second server computing device aggregating research data ingested from a plurality of information sources;
receiving, by the first server computing device, a research response from the second server computing device, the research response including:
(i) a list of items of research data corresponding to the research request, and;
(ii) a confidence rating associated with each item of research data;
analyzing, by the first server computing device, the list of items of research data in the research response using a first predetermined metric threshold, the first predetermined metric threshold based on at least:
(i) the confidence rating associated with each item of research data; and
(ii) a predetermined reliability rating of the information source associated with each item of research data;
formatting, by the first server computing device, a research result including the items of research data that exceed the first predetermined metric threshold; and
providing, by the first server computing device, the research result to the client device.

2. The computerized method of claim 1 further comprising:
ingesting, by the second server computing device, research data from one or more real-time information sources.

3. The computerized method of claim 1 further comprising determining, by the first server computing device, a location of the client device based on one or more of global positioning system (GPS) coordinates provided by a mobile device, an internet protocol (IP) address of the client device, radiolocation information from a cellular network used by the client device, and physical location data obtained from a positioning system in communication with the client device.

4. The computerized method of claim 3 wherein generating the research request is further based on the location of the client device.

5. The computerized method of claim 4 wherein generating the research request is further based on one or more of a time of day the client device is at the location and a duration the client device remains at the location.

6. The computerized method of claim 1 further comprising:
assigning, by the first server computing device, a weight value to each item of research data included in the research result, the weight value calculated based on:
(i) an impact to an investment vehicle discussed in at least one of the items of research data, wherein an impact is predicted or realized, and wherein an impact is further an increase in a value, a decrease in a value, or a substantially unchanging value; and
(ii) a ratio of the value of the impacted investment vehicle in an investment portfolio owned by the account owner to the overall value of the investment portfolio owned by the account owner; and
sorting, by the first server computing device, the items of research data included in the research result based on the weight value.

7. The computerized method of claim 6 wherein formatting the research result further comprises sorting, by the first server computing device, the items of research data included in the research result based on the weight value.

8. The computerized method of claim 6 further comprising:
assigning, by the first server computing device, a second weight value to each item of research data included in the research result, the second weight value calculated based on one or more of:
(i) a publication date of the item of research data; and
(ii) a volume of items of research data included in the research response that discuss the same impacted investment vehicle;

9. The computerized method of claim 8 wherein formatting the research result further comprises sorting, by the first server computing device, the items of research data included in the research result based on one or more of the first weight value and the second weight value.

10. The computerized method of claim 1 further comprising:
analyzing, by the first server computing device, the list of items of research data using a second predetermined metric threshold, the second predetermined metric threshold based on at least:
(i) the confidence rating associated with each item of research data; and
(ii) the predetermined reliability rating of the information source associated with each item of research data;
supplementing, by the first server computing device, the research request based on the user profile data when the list of items of research data is between the first predetermined metric threshold and the second predetermined metric threshold;
transmitting, by the first server computing device, the supplemented research request to the second server computing device; and
receiving, by the first server computing device, a second research response from the second server computing device.

11. The computerized method of claim 1 wherein the user profile data comprises one or more of financial account position data, an investment goal, an area of interest, a customer service level, an investment type preference indication, and a risk tolerance.

12. The computerized method of claim 1 wherein the user profile data comprises a list of prior research requests associated with the account owner and a list of prior research responses associated with the account owner.

13. The computerized method of claim 1 wherein the plurality of information sources includes one or more of proprietary information, a financial news website, a general news website, a political news website, a social media website, a world news website, and an RSS server.

14. The computerized method of claim 13 wherein the proprietary information includes one or more of historical pricing data for one or more financial vehicles, a fund prospectus, a financial whitepaper, and a financial research opinion.

15. The computerized method of claim 1 wherein formatting the research result comprises:
generating a list of the items of research data that exceed the first predetermined metric threshold; and
generating a list of one or more ticker symbols for investment vehicles discussed in the items of research data that exceed the first predetermined metric threshold.

16. The computerized method of claim 15 wherein the research result comprises one or more of:
(i) a list of hyperlinks;
(ii) a digest of the items of research data that are above the first predetermined metric threshold; and
(iii) the confidence rating associated with each item of research data that exceeds the first predetermined metric threshold.

17. The computerized method of claim 1 further comprising:
spawning, by the first server computing device, a first thread configured to store the research request to a database; and
spawning, by the first server computing device, a second thread configured to transmit the research request to the second server computing device, receive the research response from the second server computing device, and store the research response received from the second server computing device to the database,
wherein the first thread and the second thread execute asynchronously.

18. The computerized method of claim 10 wherein supplementing further comprises:
formatting, by the first server computing device, a research result including an indication that additional user query data is needed;
transmitting, by the first server computing device, the research result to the client device;
receiving, by the first server computing device, additional user query data from the client device; and
integrating, by the first server computing device, the additional user query data with the user profile data.

19. The computerized method of claim 1 wherein the client device is a smartphone device, a personal computing device, a tablet computing device, a telephone, or a wearable communications and computing device.

20. The computerized method of claim 1 further comprising providing, by the first server computing device, the research result to a second client device.

21. The computerized method of claim 1 further comprising sanitizing, by the first server computing device, the user query data before generating the research request.

22. The computerized method of claim 21 wherein sanitizing comprises removing, by the first server computing device, from the user query data, one or more of a financial account number and personally identifiable information of the account owner.

23. The computerized method of claim 1 wherein generating further comprises processing, by the first server computing device, the user query data with a natural language processing engine.

24. A computerized method for providing a research alert tailored to user profile data of an account owner, the method comprising:
receiving, by a first server computing device, a research response including a plurality of items of research data from a second server computing device, the second server computing device aggregating research data from a plurality of real-time information sources;
determining, by the first server computing device, an impact to an investment vehicle discussed in one or more items of research data, wherein the impact is predicted or realized, and wherein the impact is further an increase in a value of the investment vehicle, a decrease in a value of the investment vehicle, or a substantially unchanging value of the investment vehicle;
retrieving, by the first server computing device, user profile data associated with an account owner of one or more financial accounts;
determining, by the first server computing device, an impact to a value of an investment portfolio owned by the account owner based on the impacted investment vehicle discussed in the one or more items of research data;
assigning, by the first server computing device, a weight value to each of the one or more items of research data discussing the impacted investment vehicle, the weight value being based on one or more of:
(i) a predetermined reliability rating of the information source associated with each of the one or more items of research data discussing the impacted investment vehicle; and
(ii) a ratio of the value of the impacted investment vehicle in the investment portfolio owned by the account owner to the overall value of the investment portfolio owned by the account owner;
formatting, by the first server computing device, a research alert including the one or more items of research data discussing the impacted investment vehicle having a weight value that exceeds a first predetermined metric threshold; and
providing, by the first server computing device, the research alert to the account owner.
